(19) United States
(12) Patent Application Publication
(10) Pub. No.: US 2006/0191382 A1
(43) Pub. Date: Aug. 31, 2006

(54) Socket ratchet wrench system with pivoting, sleeved handle and/or interchangeable gear housings and drives

(76) Inventor: Theodore G. Pettit, Norwood, CO (US)

Correspondence Address: Theodore Gordon Pettit, 1525 San Miguel, PO Box 964, Norwood, CO, 81423, US

(21) Appl. No.: 11/337,459

(22) Filed: Jan. 23, 2006

Related U.S. Application Data
(60) Provisional application No. 60/646,723, filed on Jan. 25, 2005.

(51) Int. Cl. B25B 13/46; B25B 23/16; B25G 1/00

(52) U.S. Cl. 81/60; 81/177.8; 81/177.7

(57) ABSTRACT

The socket ratchet wrench of the present invention is a utility tool designed to more efficiently perform the task of tightening or loosening a nut or bolt, or some similar fastener. The present invention comprises a ratchet gear housing, which contains the drive, gear and switch; a handle unit containing a solid handle, straight or flexed, and an outer sleeve; all of which can be manufactured of steel or some similarly hard, rigid and durable material.

### BACKGROUND OF THE INVENTION

1. Field of the Invention

The present invention relates to socket ratchet wrenches and specifically to a new pivoting, sleeved handle socket ratchet wrench system with interchangeable gear housings and drives, creating a more productive, easier-to-use tool.

2. Description of the Prior Act

The art of the socket ratchet wrench is long and well-known. The progression of its handle has been from a fixed solid handle, to those which can be straight or flexed, to those which have the pivoting handle. Although the pivot improves the tool's versatility, it does not address the major drawback to known socket ratchet wrenches, which is that they are, at most, 50% energy efficient. This is because for each productive turn of the socket, caused by pushing or pulling the handle unit, there is an equal, backwards non-productive push or pull where the handle unit is returned to the original position. When viewed from above, the handle unit and subsequently the drive, socket and fastener, are rotated in a clockwise direction to tighten, and counter-clockwise to loosen. The benefit of a known socket ratchet wrench is a special gear, located in the gear housing between the drive and gear switch. This allows the user to reverse the handle unit while keeping the socket, still attached to the tool, in contact with the fastener and not reversed. The tool operator moves the fastener in the desired direction to tighten or loosen, and then repositions the handle unit for additional torque. Also, the efficiency of known socket ratchet wrenches can be lowered even furthered while the tool's handle unit is repositioned. As the handle unit's rotation is reversed the drive, socket and hence fastener can also be reversed with the handle unit, as the fastener is offering such little resistance or friction. Typically, to deal with this problem the tool operator will use the other non handle-holding hand to secure the socket when repositioning the tool's handle unit, thus preserving the last torque's production, but complicating the tool's use. The socket ratchet wrench of the present invention solves these drawbacks by alleviating the operator from the need to use the second hand and, more importantly, makes the tool's use quicker and more energy-efficient and productive.

Several other drawbacks are also present with the known socket ratchet wrenches. As there is still a need, and hence a market for the different-sized drives, the cost to consumer to purchase all three of the most common and hence used sizes,¼, ⅜ and ½ inch, can be prohibitive. Also, since the weakest link, which will wear out and/or break first on known socket ratchet wrenches is the gear; the consumer must purchase an entire tool for replacement. It is from this background which socket ratchet wrench of the present invention builds.

### SUMMARY OF THE INVENTION

The socket ratchet wrench of the present invention is designed to keep all of the benefits of known socket ratchet wrenches and add a greatly improved handle unit with the ability to have interchangeable gear housings. In particular, the present invention includes a pivoting handle unit with an outer sleeve over the solid handle. In various embodiments, the pivot or connection between the handle unit and gear housing can be designed to be closer or father away from the drive, depending upon factors such as expected location of intended use or resistance of fasteners. The socket ratchet wrench of the present invention allows for differing resistance from the fastener. With a greater resistance, the handle unit can rest or remain in the horizontal position, similar to known socket ratchet wrenches, thus allowing for maximum torque. With a lesser resistance, however, the handle unit can pivot up to, or past the vertical position, while allowing the gear housing, drive and socket to remain in the horizontal position and maintain full contact with the fastener. The sleeve over the solid handle allows the user to maintain a firm grip while the tool's handle unit is raised and can rotate the gear housing, drive, socket and fastener a full 360 degrees or more. In operation, once the handle unit is lifted above horizontal, the fastener is tightened or loosened by means of a stirring motion. This forward motion, without having to reposition the handle unit, translates into 100% energy efficiency and a higher productivity.

The ability to have different interchangeable gear housings is a benefit to the producer and operator of the tool of the present invention. With this possible embodiment, the user can remove the handle peg, disconnecting the gear housing from the handle unit, solid or sleeved, and replace with another gear housing, therefore improving the tool's versatility. The present invention would eliminate the production, packaging and shipping costs for 2 handle units for a 3-size drive package, as well as provide a core situation which would increase consumer loyalty and future sales by allowing the broken gear housing to be taken to a retailer for exchange.

### BRIEF DESCRIPTION OF THE DRAWINGS

The present invention will be better understood with the viewing of these drawings. Those experienced in this art will also understand the many embodiments, shown and not, which can be concluded from the present invention.

FIG. 1 is a side, bottom and top view of a pivoting, sleeved handle socket ratchet wrench system according to the present invention.

FIG. 2 is an exploded bottom view of a pivoting, sleeved handle socket ratchet wrench system according to the present invention.

FIG. 3 is an exploded top view of a pivoting, sleeved handle socket ratchet wrench system according to the present invention.

FIG. 4 is an exploded side view of a pivoting, sleeved handle socket ratchet wrench system according to the present invention.

FIG. 5 is an exploded side, top and bottom view of the different interchangeable gear housings and removable handle peg of the socket ratchet wrench system of the present invention.

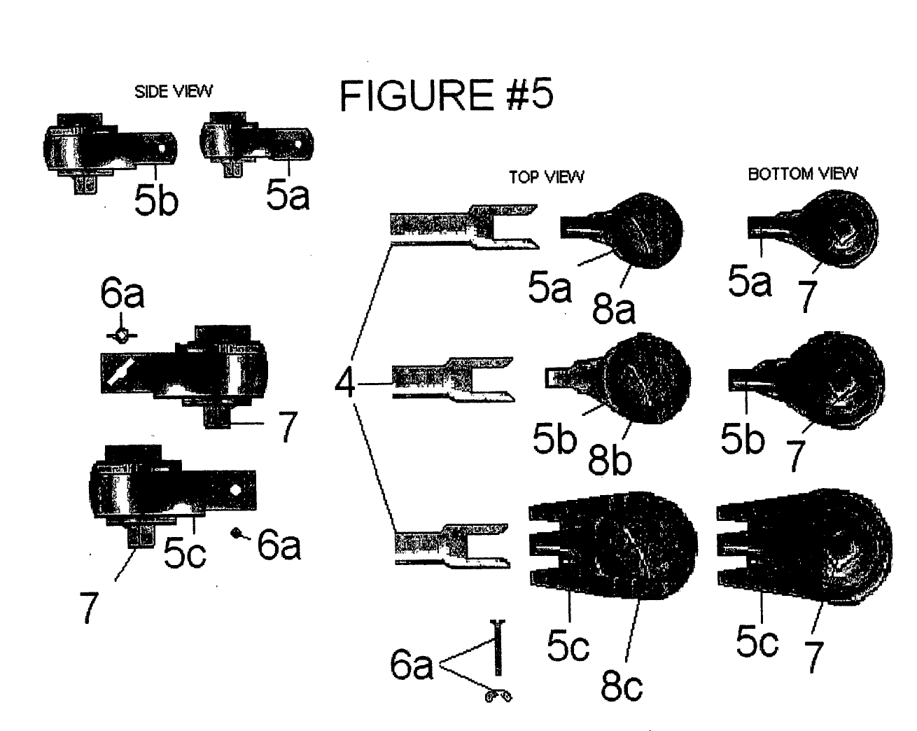

FIG. 6 is a side, top and bottom view of the possible horizontal and side supports and/or guides for the handle unit at the pivot of the socket ratchet wrench system according to the present invention.

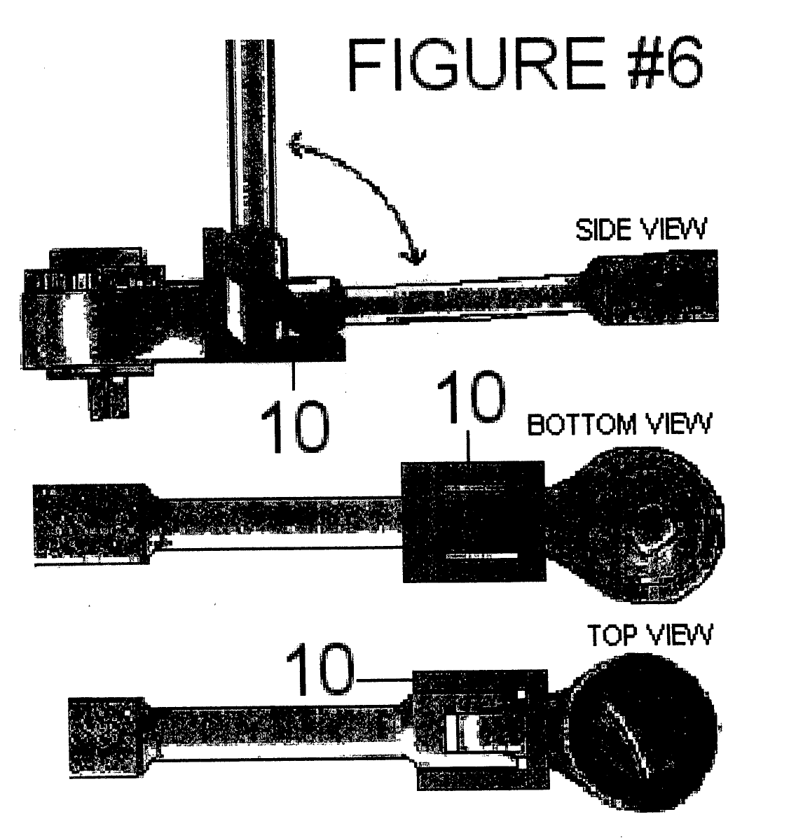

### DESCRIPTION OF THE PREFERRED EMBODIMENT

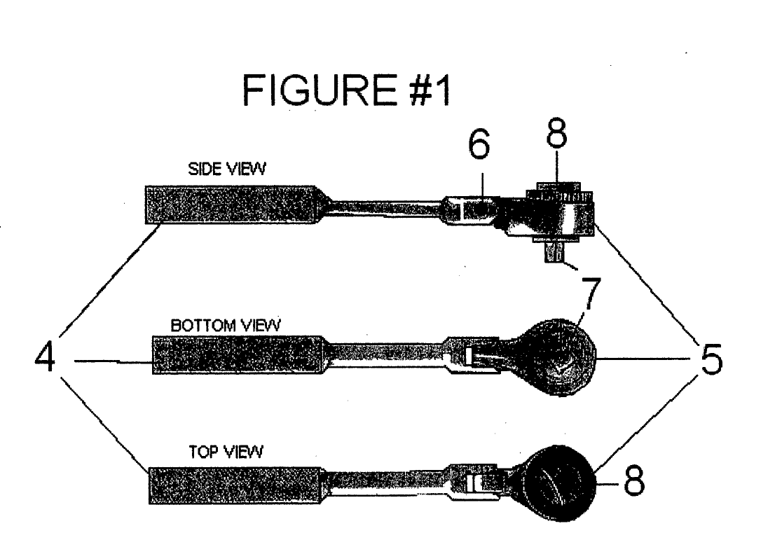

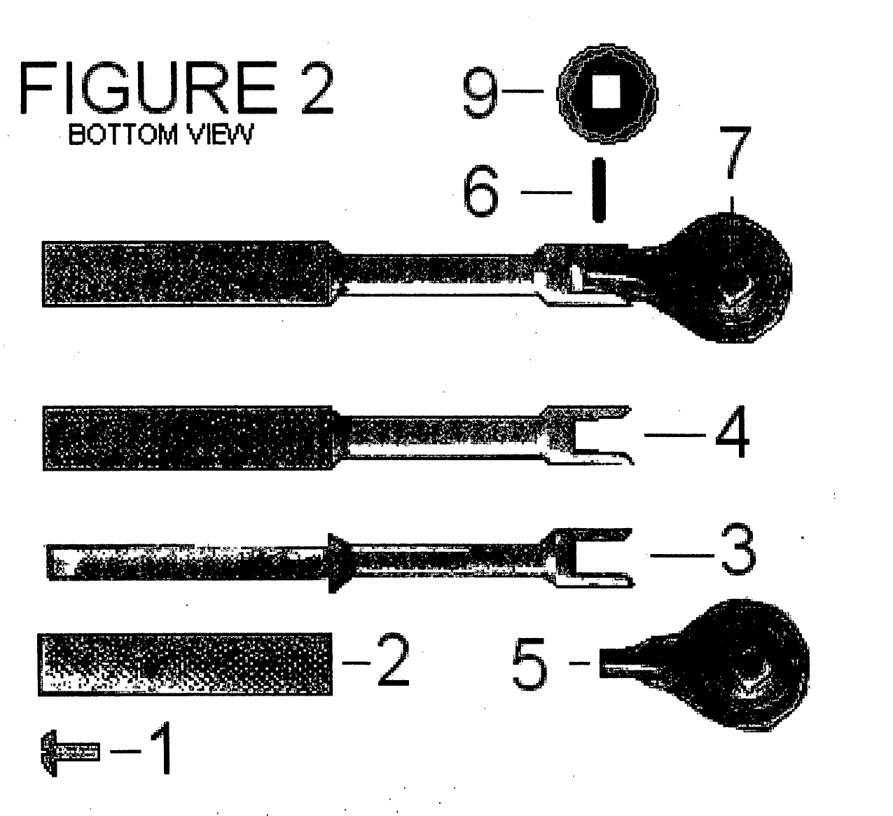

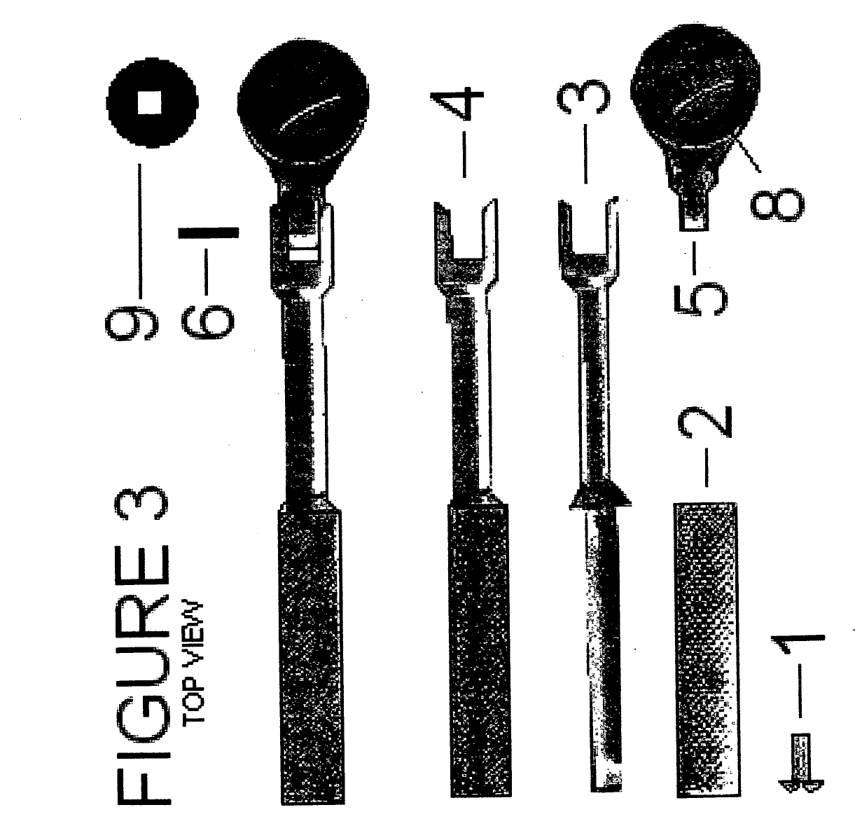

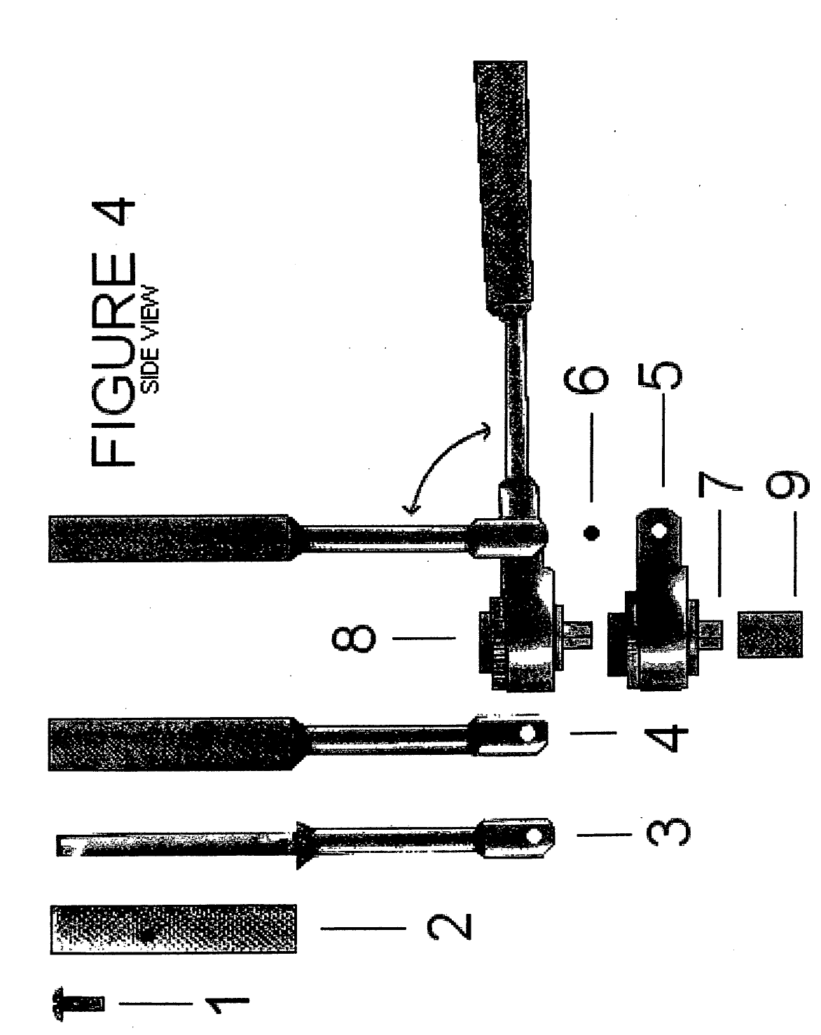

The socket ratchet wrench system of the present invention is a utility tool designed to perform the task of tightening or loosening a nut or bolt, or some similar fastener. As shown in FIGS. 1, 2, 3 and 4 the socket ratchet wrench system according to the present invention comprises a gear housing #3, a handle unit #4 and a socket #9, all of which can be made of steel or some similarly hard, rigid and durable material. The drive #7, which can be of varying sizes with the most common being ¼, ⅜ and ½ inch, for example, is located on the bottom of the gear housing #5. The direction for the tool's use is determined by the gear switch #8, located on the top of the gear housing #5. The direction for the tool's use is determined by the gear switch #8, located on the top of the gear housing #5. The handle unit #4, which can be of varying lengths and diameters, comprises a solid handle #3, straight or flexed, a cylindrical sleeve #2, also of varying sizes, which fits over the solid handle #3 and a sleeve screw #1, which holds the sleeve #2 in place while maintaining its ability to rotate around the solid handle #3. It is possible to manufacture the sleeve #2 and solid handle #3 together, without the need for a sleeve screw #1. The handle unit #4 is coupled with the gear housing #5 with a handle peg #6, which can be fixed or removable.

The removable handle peg #6a allows for different, interchangeable gear housings #5a, 5b and 5c, which have been manufactured to connect with the same handle unit #4. With this embodiment, the tool operator can remove the handle peg #6a, disconnecting the gear housing #5a, 5b or 5c from the handle unit #4, and replace with another gear housing #5a, 5b or 5c with its different drive size #7a, 7b or 7c with a new replacement gear housing #5a, b or c.

I claim:

1. A ratchet wrench comprising:
a gear housing assembly comprising a drive head, and a rotatable gear having gear teeth and disposed within the drive head;
a handle assembly comprising a sleeve rotatably coupled around a handle body, and a sleeve fastener for coupling the sleeve to the handle body; and
a handle fastener coupled to the gear housing assembly and the handle assembly, wherein the handle assembly can pivot approximately 90 degrees.

2. The ratchet wrench of claim 1, wherein the gear housing assembly further comprises a switch connected to the rotatable gear for allowing the rotatable gear to rotate in either a clockwise or a counterclockwise direction.

3. The ratchet wrench of claim 1, wherein the sleeve is substantially cylindrical in shape.

4. The ratchet wrench of claim 1, wherein the handle body is substantially straight in shape.

5. The ratchet wrench of claim 1, wherein the handle body is curved in shape.

6. The ratchet wrench of claim 1, wherein the handle fastener is removable.

7. The ratchet wrench of claim 1, wherein the gear housing assembly further comprises a support member for supporting the handle assembly.

8. The ratchet wrench of claim 1, wherein the gear housing assembly further comprises a support member for guiding the handle assembly.

9. The ratchet wrench of claim 1, wherein the gear housing assembly further comprises a stop member for limiting the travel of the handle assembly.

10. A ratchet wrench comprising:
a gear housing assembly of one more predetermined sizes comprising a drive head, and a rotatable gear having gear teeth and disposed within the drive head;
a handle; and
a handle fastener coupled to the gear housing assembly and the handle, wherein the handle can pivot approximately 90 degrees.

11. The ratchet wrench of claim 10, wherein the gear housing assembly further comprises a switch connected to the rotatable gear for allowing the rotatable gear to rotate in either a clockwise or a counterclockwise direction.

12. The ratchet wrench of claim 10, wherein the handle is substantially straight in shape.

13. The ratchet wrench of claim 10, wherein the handle is curved in shape.

14. The ratchet wrench of claim 10, wherein the handle fastener is removable.

15. The ratchet wrench of claim 10, wherein the gear housing assembly further comprises a support member for supporting the handle assembly.

16. The ratchet wrench of claim 10, wherein the gear housing assembly further comprises a support member for guiding the handle assembly.

17. The ratchet wrench of claim 10, wherein the gear housing assembly further comprises a stop member for limiting the travel of the handle assembly.

18. A ratchet wrench comprising:
an interchangeable gear housing assembly of one more predetermined sizes comprising a drive head, and a rotatable gear having gear teeth and disposed within the drive head;
a handle assembly comprising a sleeve rotatably coupled around a handle body, and a sleeve fastener for coupling the sleeve to the handle body; and
a handle fastener coupled to the gear housing assembly and the handle assembly, wherein the handle assembly can pivot approximately 90 degrees.

19. The ratchet wrench of claim 18, wherein the interchangeable gear housing assembly further comprises a switch connected to the rotatable gear for allowing the rotatable gear to rotate in either a clockwise or a counterclockwise direction.

20. The ratchet wrench of claim 18, wherein the handle fastener is removable.
